(19) United States
(12) Patent Application Publication
(10) Pub. No.: US 2025/0130041 A1
(43) Pub. Date: Apr. 24, 2025

(54) METHOD FOR ASCERTAINING THE DEFORMATION OF A TIRE SUBJECTED TO AN EXTERNAL STRESS WHILE ROLLING

(71) Applicant: COMPAGNIE GENERALE DES ETABLISSEMENTS MICHELIN, Clermont-Ferrand (FR)

(72) Inventors: SIMON NUYTTEN, Clermont-Ferrand (FR); DENIS MARTIN, Clermont-Ferrand (FR)

(21) Appl. No.: 18/681,570

(22) PCT Filed: Aug. 1, 2022
(86) PCT No.: PCT/FR2022/051538

§ 371 Date: Feb. 6, 2024

(30) Foreign Application Priority Data
Aug. 6, 2021 (FR) 2108542

(51) Int. Cl. G01B 21/32; B60C 23/06

(52) U.S. Cl. CPC G01B 21/32; B60C 23/062; B60C 23/064

(57) ABSTRACT

A method for ascertaining the deformation of a tire comprises: fastening to the tire a sensor able to generate a signal sensitive to the movement of the sensor; acquiring (201) a temporal wheel-turn signal Sig^{TDR} (101) comprising the amplitude of the movement while rolling; determining a reference speed W^{reference} (202) associated with a portion of the wheel-turn signal Sig^{TDR}; normalizing (203) the portion of the wheel-turn signal Sig^{TDR} by a variable which is a function F of W^{reference}; angularly resampling (204) the portion of the wheel-turn signal Sig^{TDR}; obtaining the spectral signal (205) of the portion of the normalized and angularly resampled wheel-turn Sig^{TDR}; defining a spectral variable (206); and identifying the deformation of the tire Def % (207) as a function G of the spectral variable.

### FIELD OF THE INVENTION

The present invention concerns the field of measurement signals supplied by measurement means mounted on the mounted assembly of a terrestrial vehicle while rolling.

### Technological Background

Recent developments in connected mounted assemblies, measuring physical variables of the mounted assembly by means of on-board sensors in the mounted assembly, lead to determination of the state of the mounted assembly and hence open the door for the development of services linked to monitoring the state of the mounted assembly. Although general variables measured, such as the inflation pressure of the mounted assembly or the temperature of this mounted assembly, are not very sensitive to measurement noise generated by rotation of the mounted assembly on a surface of random roughness since these general variables vary only slightly during rotation of the mounted assembly, finer variables are highly sensitive to physical phenomena linked to the rotation of the mounted assembly. Furthermore, the mounted assembly is subjected to external forces. Some are linked to movement of the mounted assembly, such as rolling resistance. Other forces apply at any instant, and in particular while static, such as load. These applied forces may affect the fine variables to be measured. Finally, new services require cleaning of the physical variables directly measured before obtaining useful information from measurement signals, such as the deformation of the tyre casing.

One of the objects of the invention below is to solve the problems of disruption of measurement signals generated by a sensor so as to obtain only a measurement cleaned of disruption of certain physical phenomena, with the aim of obtaining a scalar value, for the deformation of the tyre casing.

In order to gain a better understanding of the invention, the circumferential direction S, axial direction A and radial direction R are directions defined with respect to the rotating frame of reference of the tyre casing about its natural axis of rotation. The radial direction R is the direction extending perpendicularly away from the natural axis of rotation. The axial direction A is the direction parallel to the natural axis of rotation. Finally, the circumferential direction S forms a direct trihedron with the predefined radial and axial directions.

### DESCRIPTION OF THE INVENTION

The invention concerns a method of ascertaining the deformation of a tyre casing. The tyre casing is in a state mounted on a wheel so as to constitute a pneumatic mounted assembly in rolling state with rotation speed W, and subjected to external forces, for example a static load. The tyre casing has a crown in contact with the ground and in revolution about a natural rotational axis. The method comprises the following steps:
Fastening at least one sensor to the tyre casing at the crown of the tyre casing so as to generate at least one output signal sensitive to the movement of said sensor in the tyre casing;
Acquiring at least one first temporal signal Sig comprising at least the amplitude of movement while rolling;
Delimiting the first signal over a number N^{TDR} of wheel turns, N^{TDR} being greater than or equal to 1, so as to construct a wheel-turn signal Sig^{TDR};
Determining at least one reference speed W^{referenee} associated with at least one portion of the wheel-turn signal Sig^{TdR};
Normalizing the at least one portion of the wheel-turn signal by a variable which is a function F of the at least one reference speed W^{referenee};
Angularly resampling the at least one portion of the wheel-turn signal Sig^{TDR};
Obtaining the spectral signal spect(Sig) of the at least one portion of the normalized angularly resampled wheel-turn signal;
Defining at least one spectral variable on the spectral signal spect(Sig);
Identifying the deformation Def % of the tyre casing as a function G of the at least one spectral variable.

The term “movement of the sensor” here indicates the movement or speed or acceleration applied to the sensor in absolute terms relative to a Galilean reference, but also the deformation or rate of deformation or acceleration of deformation which is applied to said sensor, i.e. in relative terms between the various elementary units of the sensor. Therefore the sensor output signal is sensitive to at least one of these six components of movement of the sensor.

The signal recovered from the sensor is the temporal amplitude of the movement of the sensor during rolling of the mounted assembly under the specified conditions. Thus the acquired signal displays the variations in amplitude of the movement over a portion of the wheel turn for the tyre casing, including potentially those associated with the crossing of the contact patch by the portion of the tyre casing where the sensor is mounted, but also those associated with other specific zones of the wheel turn, such as that corresponding to the angular sector opposite the contact patch which is susceptible to counter-deflection, or those corresponding to angular sectors situated at 90 degrees from the contact patch relative to the axis of rotation. In all these zones, variations in movement of the sensor can potentially be observed on the output signal depending on the sensitivity of the sensor.

This first acquired signal is associated with a reference speed which can be identified on this first signal or result from another source such as another signal, or the output of a variable by a system external to the mounted assembly. This reference speed is necessarily associated with the same time frame as the portion of the first signal. This reference speed serves to normalize the amplitude of the first signal using a function F, the variable of which is the reference speed. The function F may be a linear function, a power function, an exponential function or the constant function. The sensor signal is normalized as a function of the dependency of the amplitude of the sensor signal on the reference speed, if this dependency is perceived as a parasitic signal of the tyre casing deformation. Thus the first normalized signal becomes independent of this reference speed. For example, this reference speed may be the rotation speed of the mounted assembly, or the translation speed of the mounted assembly in the direction of movement of the mounted assembly. Therefore the first signal may be used independently of the reference speed, which is linked to the rotation of the mounted assembly.

The method also comprises a step of delimiting the first signal Sig over a number of wheel turns with the aim of using the periodicity of the sensor signal to the natural rotation of the tyre casing in rolling condition. Thus it is possible to perform a high-quality spectral analysis on the data from the wheel-turn signal. However, for this step it is not essential that the number of wheel turns is integral, and the signal may be delimited over an actual number of wheel turns, as long as this number of wheel turns is at least greater than 1. Preferably, several wheel turns are used.

The method also comprises an angular resampling of the first signal or the wheel-turn signal, which may take place before or after the step of normalization. This step allows the temporal signal to be transformed into a spatial signal by phasing the temporal signal relative to one or more angular references of the mounted assembly. This angular reference may firstly be taken from the first signal by a particular response of the sensor to an individual azimuth on the wheel turn. However, this angular reference may also be taken from another signal of a sensor which shares a common timer with the first signal. This shared timer or synchronization of signals is natural if the two sensors are taken from the same device or if the signals are transmitted to a common device. This angular resampling naturally allows generation of a spatial signal periodic to the wheel turn. For this, to generate a perfectly angularly periodic signal, it is sufficient to interpolate the signals over a set angular division. But if the mounted assembly is subject to movement at variable speed, this resampling still allows generation of an angularly periodic signal.

The method comprises a step of performing a spectral analysis from the portion of the angularly resampled normalized wheel-turn signal. It is useful here to ensure that the portion of the initial signal is defined by a constant angular pitch, which ensures regular spatial discretization of the sensor signal. As required, the step of angular resampling ensures that the angular pitch is fixed, allowing a high-quality spectral analysis, which may require a method of interpolation of measurement points in order to redefine a signal with fixed angular pitch.

The method comprises a step of defining a spectral variable or several spectral variables associated with the spectral signal resulting from the preceding step.

Finally, the method comprises determination of the deformation of the tyre casing through a function G of the spectral variable identified in the preceding step. This deformation is expressed in the form of a scalar or vector which is an invariant of the tyre casing in rolling condition subjected to external forces such as static load.

Advantageously, the step of determining the reference speed W^{reference} consists of establishing the ratio of the angular variation to the temporal duration separating two azimuthal positions of the sensor in the tyre casing around the natural axis of rotation, from the wheel-turn signal Sig^{TDR} or from a signal in phase with the first signal Sig^{TDR} according to the following formula:

$${W}^{r e f e r e n c e} = Δ ( α ) / Δ ( t ) \qquad [ Math 1 ]$$

wherein α is the angular position and t is the temporal abscissa associated with the angular position.

In the case where the reference speed corresponds to the angular rotation speed of the tyre casing, this reference speed is calculated over an angular variation of the signal between two known positions. Preferably, this reference speed is evaluated over a signal duration of less than one wheel turn, which allows rapid definition thereof and performance of the step of normalization of a portion of the first signal at the electronic device associated with the sensor. Moreover, this then allows angular resampling of the portion of the first signal with better precision if the tyre casing moves with a variable angular speed. In fact, at the level of a wheel turn, the variation in angular speed is necessarily small for a tyre with a development which may extend to 2 metres for a car tyre or 3 metres for a truck tyre. The acceleration or deceleration applied to the tyre casing over this length is naturally low with drive and braking systems of current vehicles. Naturally, it is quite possible to integrate a variation in angular speed during the wheel turn with a finer azimuth setting, so as to take account for example of micro-variations in angular speed which occur during the wheel turn, such as for example before and after passing through the contact patch or when encountering a discontinuity in movement over the ground, such as a transverse bar on the ground. This precision of reference speed during a wheel turn then allows a more precise normalization of the signal, but also an increased angular precision in the angular position of the measurement points of the first signal during the angular resampling step, which improves the precision desired for sensing minimal variations during the wheel turn.

According to a particular embodiment, the azimuthal positions of the tyre casing are included in the group comprising an angular position which can be detected from the wheel-turn signal Sig^{TDR}, corresponding to the entry into the contact patch, the exit from the contact patch, or the central position of the contact patch, or any defined angular position from the signal in phase with the wheel-turn signal Sig^{TDR}.

These are azimuthal positions which affect the signal from the movement sensor and correspond to specific angular positions. Therefore these positions are easy to identify on the signal from the sensor. Furthermore, it is easy to assign their azimuthal references. In fact the central position of the contact patch corresponds to an azimuthal position of 0 or 180 degrees relative to the normal to the ground. If a contact patch length is determined through the entry and exit points of the contact patch, the angle formed by the contact patch can be established as the ratio of the contact patch length to the development of the tyre casing over one wheel turn or 360 degrees. The sector formed by the contact patch on either side of the normal to the ground is evenly divided. Naturally, access to a signal other than the first signal also allows an angular sectorization which is finer than one wheel turn, as an angular encoder.

According to a very particular embodiment, determination of the entry and exit of the contact patch on the first signal comprises the following steps:
Defining a threshold value B which is a function of the at least one maximum of at least a second portion of the first signal;
Identifying a first series of increments I, corresponding to the abscissa value t of the at least one first signal at which the first signal crosses a threshold value B in a given crossing direction;
The totality of increments I or the increments I of the same parity represent the entry or exit of the contact patch.

Advantageously, the threshold value B is a value ranging between 0.1 and 0.5 of the at least one maximum of at least one portion of the first signal.

This is an embodiment attached to the detection of positions associated with the entry and exit of the contact patch. The strong variation in movement which occurs at these two positions of the wheel turn allows application of an elementary method for determining these two points by directly processing the first signal at the electronics of the sensor for example. Depending on choice of detection of the direction of crossing the threshold, it is possible to directly determine the entry or exit of the contact area on various signals. The diversity of signals concerns firstly the direction of observation of the variable, the variation in movement in the radial or circumferential direction of the tyre casing, and secondly the nature of the signal, an accelerometric signal, a signal of deformation in a radial direction, etc.

In absolute terms, we are not aiming to identify the precise position of the contact patch which depends on variable phenomena in the wheel turn. The method used in the data aggregation step does not necessarily require an increased precision in the absolute position of the entry and exit of the contact patch. The robustness of the method allows a high reproducibility of determination of the central position of the contact patch irrespective of the nature of the first signal which is the result of the entry and exit positions of the contact area.

Advantageously, the angular pitch is less than 18 degrees.

It can thus be ensured that one of the measurement points is situated in the contact patch. Therefore resulting movement variations will be observed at least between this sampling point and the closest neighbouring points, allowing determination of entry and exit points of the contact patch in the first signal.

Highly advantageously, the angular pitch is less than 6 degrees, preferably less than 3 degrees.

Use of a finer angular pitch allows sensing of several measurement points in the contact patch, and hence observation on the first signal of deformation phenomena at the scale of the contact patch and no longer at the level of the wheel turn. This fineness of observation gives access to different observable variables which are relevant for certain specific applications. For example, in the case of wet road conditions, at the contact patch we see a pool of water at the front of the contact patch, which modifies the geometry of the contact patch. The observation of several points at the level of the contact patch allows measurement of the width of this water pool and its effects on the mechanics of the tyre casing.

According to a very particular embodiment, the method comprises the step of aggregating the data from the at least one portion of the angularly resampled normalized wheel-turn signal Sig^{TDR} over at least one sub-portion of the at least one portion of the angularly resampled normalized wheel-turn signal Sig^{TDR}, the sub-portion of the at least one portion of the angularly resampled normalized wheel-turn signal Sig^{TDR} becoming the at least one portion of the angularly resampled normalized wheel-turn signal Sig^{TDR}.

Advantageously, the sub-portion of the at least one portion of the wheel-turn signal Sig^{TDR} is an integral multiple of a wheel turn.

The method preferably comprises a data aggregation step which allows aggregation of data for several angular periods of the wheel turn over a portion of the wheel turn, whether this is an integral wheel turn or an integral multiple of a wheel turn. Thus the signal data over this partial angular sectorization are multiplied, which takes into account all variations on the scale of a wheel-turn period, such as the granulometry of the ground or an isolated obstacle on the road. The aggregation consists of averaging the data from various wheel turns into a single value at a selected azimuth of the angular sectorization. This is equivalent to filtering or averaging the random phenomena on a wheel turn over several wheel turns, which improves the quality of the sensor signal. Naturally, it is necessary that the specific angular pitch for the angular sectorization resulting from the aggregation step is a fixed angular pitch, which ensures a high-quality spectral analysis.

Also, if the angular pitch is fine, it allows angularly minimal variations to be taken into account, these variations being periodic to the wheel turn, using several wheel turns in homogeneous fashion. These minimal variations are obtained without having a high temporal discretization, although the higher the discretization, the shorter the signal necessary for determining these minimal variations. It is this step which guarantees the value added to the initial signal from the sensor.

To determine the global deformation of the tyre casing subjected to external forces, the optimal sub-portion defined at the data aggregation step is the wheel turn or an integral multiple of a wheel turn, so as to benefit from the angular periodicity of the wheel turn. The data aggregation step may take place over one wheel turn, which is the natural angular period of the tyre casing. Thus the method is ideal for observing the deformations of the tyre casing over a wheel turn. This gives a reasonable size of signal to be analysed, while focussing on one angular sector of observation and still benefiting from the natural periodicity of the tyre casing to the wheel turn.

According to a preferred embodiment, the data aggregation step comprises one of the methods contained in the group comprising the mean over a decile interval, the median, the selection or interval of deciles, the methods of interpolation, the weighted or non-weighted mean, optimization of the parametric model of tyre deformation.

The purpose of aggregation is to set the measures performed over a new angular distribution of the first signal in order to make sense of the set of raw measurement data, while not prioritizing one zone over another because of an abundance of measurement points. The aggregation step is intended to supply a balanced signal in terms of measurement points with an angular pitch selected by the operator according to the tyre casing deformation to be observed. To this end, the method of optimizing the parametric model of the tyre deformation is ideal, since this parametric model may be theoretical, not taking into account measurement noise linked to the entire measurement chain applied. The output signal from the aggregation step is a theoretical output of the parametric model having minimal spread with the set of measurement points recorded.

According to a particular embodiment, the at least one spectral variable is identified on the first positive frequency block of the spectral signal spect(Sig).

Preferably, the at least one identified spectral variable is contained in the group comprising the maximum value, the median value, the mean value, the pass-band of the first block, the area below the curve of the first block, the frequency of the median value, the frequency of the mean value, the frequency of the maximum value.

Preferably, the function G is a linear function of the at least one spectral variable.

The applicant was surprised to find that study of the first positive frequency block of the spectral signal spect(Sig) was sufficient to identify one or more variables associated with this first block which are relevant for determining, at the end of the method, the tyre casing deformation with adequate quality. The variables most sensitive to tyre casing deformation are specified in the list provided. These are standard variables of a spectral signal requiring few calculation resources, which is favourable for the method. Furthermore, these variables are sensitive mainly to tyre casing deformation, and much less to secondary variables. Consequently, these variables are ideally suited for example to the general deformation of the tyre casing as a whole, such as deformation generated by global forces on the entire tyre casing, such as the static load.

In this case, function G need not be sophisticated; the applicant has found that a linear function G of one or more spectral variables allows suitable determination of the tyre casing deformation according to the various conditions of use of the tyre casing subjected to external stress and in particular variations in static load.

According to a preferred embodiment, the sensor is included in the group comprising accelerometer, piezoelectric sensor, magnetic sensor, inductive sensor, capacitative sensor.

All these sensor types allow observation of variations of movement, in particular at the time of passing through the contact patch, which is a specific zone in the wheel turn. Some of these sensors, such as the accelerometer, give a discrete value over a reduced spatial extent. Others, such as the piezoelectric sensor for example, give a discrete value over a large spatial extent, which allows limiting of the influence of local phenomena. Some sensors are influenced by external physical phenomena, such as terrestrial gravity as acceleration, allowing recovery of azimuthal information as required.

According to a preferred embodiment, the data aggregation step comprises one of the methods contained in the group comprising the mean over a decile interval, the median, the selection or interval of deciles, the methods of interpolation, the weighted or non-weighted mean, optimization of the parametric model of tyre deformation.

The purpose of aggregation is to set the measures performed over a new angular distribution of the first signal in order to make sense of the set of raw measurement data, while not prioritizing one zone over another because of an abundance of measurement points. The aggregation step is intended to supply a balanced signal in terms of measurement points with an angular pitch selected by the operator according to the tyre casing deformation to be observed. To this end, the method of optimizing the parametric model of the tyre deformation is ideal, since this parametric model may be theoretical, not taking into account measurement noise linked to the entire measurement chain applied. The output signal from the aggregation step is a theoretical output of the parametric model having minimal spread with the set of measurement points recorded.

According to a specific embodiment, the sensor movement is described by acceleration.

This type of sensor provides local information on the movement of the tyre because of its minimal mounting on the tyre casing. The sensor therefore suffers few disruptions to the variations in movement of the tyre casing. The miniaturization of the sensor thus allows multiplication of the observation directions by using biaxial or triaxial accelerometers, which supply multiple signals in orthogonal directions at the same physical point of installation of the sensor. Finally, acceleration is a sensitive movement signal which ensures a high sensitivity of the sensor to the movement of the tyre casing, allowing fine analysis of local phenomena which may take place at the contact patch for example.

Advantageously, having phased the first signal Sig with respect to an angular position of the tyre casing, a correction Corr is made to the first signal Sig to take account of the effect of terrestrial gravity before the normalization stage.

The drawback of the accelerometric signal is that it is sensitive to terrestrial gravity if oriented approximately parallel to terrestrial gravity. In the case of the tyre casing, the sensor is rotationally linked to the tyre casing. Therefore when the sensor is oriented radially or circumferentially, the amplitude of the sensor signal is influenced by terrestrial gravity during a wheel turn. This is reflected in the signal in the form of a sinusoidal function of amplitude linked to terrestrial gravity, with nodes at the azimuths of the tyre casing separated by 180 degrees when the orientation of the sensor is aligned with the gravitational vector, i.e. substantially perpendicular to the ground. Conversely, when the sensor is oriented parallel to the ground, which corresponds to two azimuthal positions separated from one another by 180 degrees and generally situated at approximately +/−90 degrees from the gravitational vector, the sensor signal is not influenced by terrestrial gravity. In order to eliminate this parasitic component of the accelerometric signal, the amplitude of the signal should be combined with a corresponding sinusoidal function, by having phased the first sensor signal with the vertical to the ground corresponding to the direction of the gravitational vector.

According to a very specific embodiment, the first signal Sig comprises the amplitude of acceleration in the direction normal to the crown of the tyre casing.

This is one of the two orientations sensitive to terrestrial gravity for acceleration. The orientation of the sensor within the tyre casing is easier in this direction and allows concentration of the influence of terrestrial gravity at the azimuthal positions of 0 and 180 degrees relative to the straight line perpendicular to the ground. Thus the azimuthal positions situated at +/−90 degrees from these positions are not disrupted by terrestrial gravity, which allows direct use of the signals from the accelerometer in these specific angular sectors without the step of correction for terrestrial gravity.

Highly advantageously, the function F is proportional to the square of the reference speed W^{reference}.

In the case of a signal from an accelerometer-type sensor for example in the radial or circumferential direction of the tyre casing, the sensor signal is influenced by the squared function of the reference speed. Thus the normalization step preferably uses the squared function of the reference speed, preferably the reference speed is then the angular speed of the tyre casing.

### BRIEF DESCRIPTION OF THE DRAWINGS

The invention will be better understood upon reading the following description, which is provided solely by way of a non-limiting example and with reference to the accompanying figures, in which the same reference numbers in all cases designate identical parts and in which:

FIG. 1 shows an overview of the method according to the invention.

FIG. 2 shows an illustration of a first signal from a sensor.

FIG. 3 shows the angular resampling of the wheel-turn signal.

FIG. 4 shows an illustration of the resampled normalized wheel-turn signal.

FIG. 5 shows an illustration of the final signal after data aggregation over a sub-portion of the wheel-turn signal.

FIG. 6 is an illustration of the spectral signal spect(Sig) of the wheel turn.

### DETAILED DESCRIPTION OF EMBODIMENTS

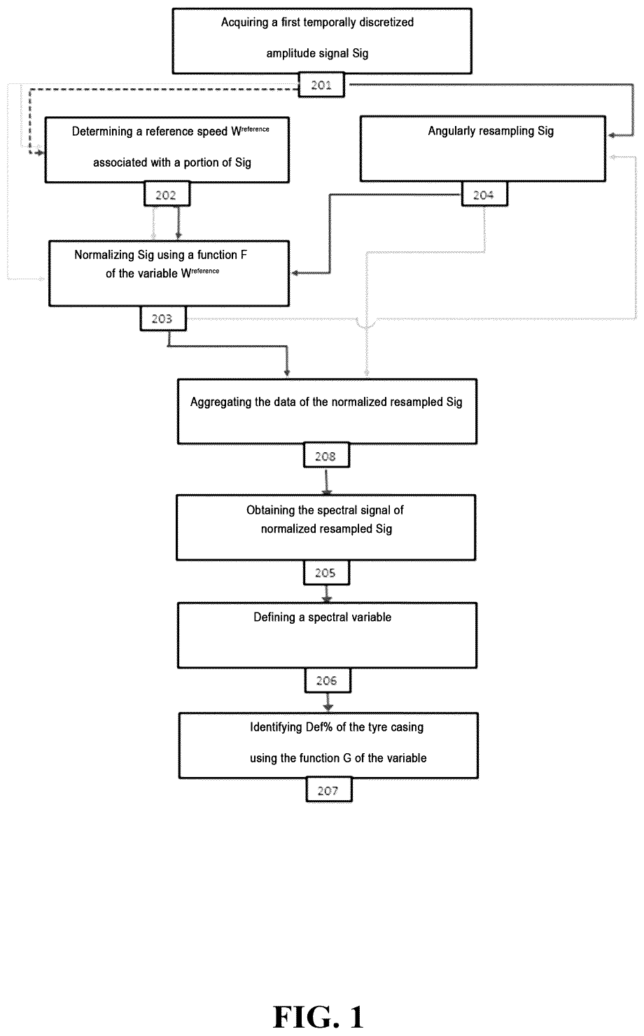

FIG. 1 shows an overview of the method according to the invention. From a first signal Sig obtained by temporal acquisition 201 of the amplitude output of a movement sensor during rolling of the tyre casing on which the sensor is mounted, a number of steps are performed following various possible pathways for obtaining a scalar representative of the final deformation of the tyre casing.

The first pathway comprises, from the temporal signal at the output of step 201, determining a reference speed W^{reference} 202 of the tyre casing in its mounted assembly configuration, i.e. tyre casing mounted on rim and inflated. Here, the first signal Sig 101 is already delimited over a certain number of wheel turns, 12 to be precise. Consequently, the first signal Sig 101 coincides with the wheel-turn signal Sig^{TDR}. This reference speed may be an angular speed linked to the natural rotation of the tyre casing around its rotational axis, but it may also be the translation speed per unit length of the tyre casing in the direction of travel thereof. This value may be determined from the wheel-turn signal Sig^{TDR} but also determined from another signal temporally in phase with the first signal and hence the wheel-turn signal Sig^{TDR}.

Then the wheel-turn signal Sig^{TDR} is normalized 203 from the first signal resulting from step 201 by a function F of the variable W^{reference} acquired in step 2. After this step 203, a normalized signal is obtained for the movement of the tyre casing in a temporal description.

The normalized signal must then be angularly resampled in order to find a signal which is angularly periodic to the wheel turn through step 204. Then after this step 204, the result is a signal normalized and angularly resampled over several wheel turns.

The second pathway comprises, from the first signal Sig which is also the wheel-turn signal Sig^{TDR} resulting from step 201, angularly resampling the first signal Sig by phasing this first signal by means of the form of the first signal or by having another signal temporally phased with the first signal. The other signal comes from another sensor, or another track of the same sensor, such as the circumferential acceleration of a three-dimensional accelerometer. This angular resampling of the first signal leads to a signal periodic to the wheel turn at the end of step 204.

After having phased this angular signal using another temporal signal, a reference speed is determined from another temporal signal in phase with the first signal. Preferably, this is the same other signal which was used for angular resampling of the first signal in step 204. Thus a reference speed W^{reference} is identified at the end of step 202.

Then the reference speed allows normalizing of the angularly resampled signal from step 204 using a function of the reference speed variable. This gives an angularly resampled normalized signal at the end of step 203.

Optionally, whichever pathway is taken, the data from the angularly resampled normalized signal resulting from step 204 on the first pathway or step 203 on the second pathway are aggregated. This data aggregation is carried out on a sub-portion of the input signal which is a multiple of a wheel turn, ideally the wheel turn, since the resampled normalized signal is periodic to the wheel turn by its nature. At this level, it is sometimes necessary to resample the aggregated signal resulting from step 207 with a fixed angular pitch in order to perform the above high-quality spectral analysis.

Alternatively, if the first signal 101 is polluted by known physical phenomena such as an accelerometer signal influenced by terrestrial gravity, it is sometimes useful—although not essential—to perform a correction of the first signal for this physical phenomenon in order to limit the parasitic noise generated by the physical phenomenon. This correction may take place at any step between step 201 and 204, but necessarily before the data aggregation step 205, which allows an improvement in the quality of the signal for tyre casing deformation. If correction takes place after the normalization step, the correction must also be normalized so as not to introduce a correction error.

Then a spectral analysis 205 is performed on the normalized resampled wheel-turn signal in step 204 or 203 depending on pathway, this being periodic to the wheel turn. If the angular pitch is not regular, measurement points should be interpolated over the theoretical points regularly spaced over the signal. In some cases, the spectral analysis step 205 is performed after a data aggregation step 207 which supplies a signal with a fixed angular pitch.

The spectral signal resulting from step 205 is analysed to extract one or more spectral variables during step 206. Said spectral variable(s) will supply a function G, which in turn will provide a vector, preferably a scalar, as an invariant of the tyre casing deformation in rolling condition subjected to external forces.

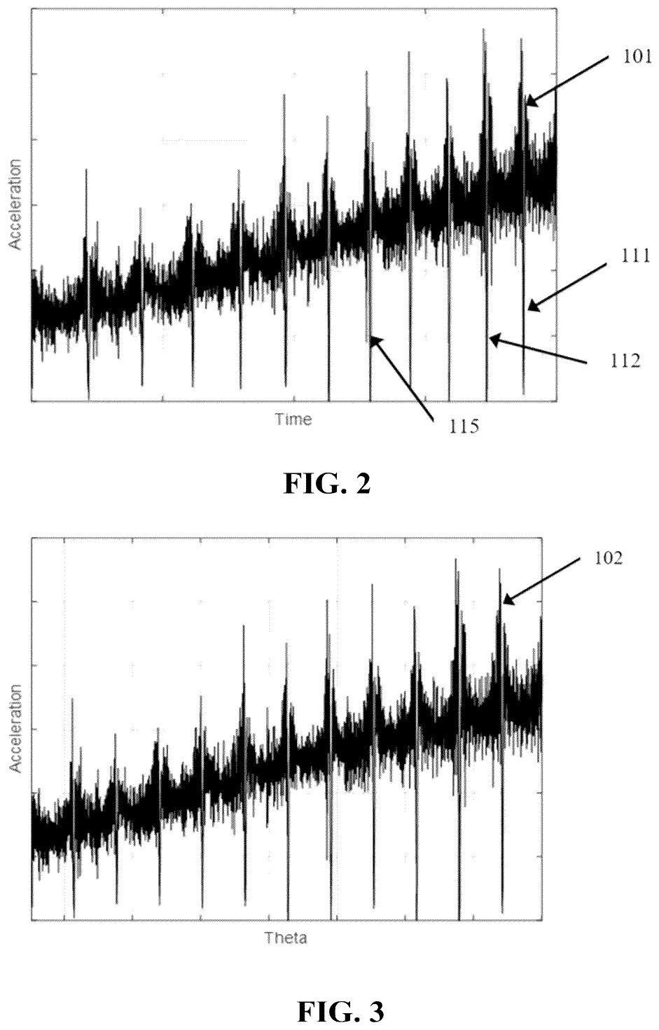

FIGS. 2 to 4 illustrate the method using the second pathway described in the overview of FIG. 1. The illustration is given for an accelerometer fixed at the crown of a tyre casing mounted on the inner liner of the tyre casing. Here, the tyre casing is a MICHELIN CrossClimate in size 265/65R17 under a static load of 800 daN when mounted on a motor vehicle. The mounted assembly was inflated to 3 bar. Measurements were performed during travel of the vehicle on asphalt circuits with varying roughness, under standard conditions of speed and load applied according to the tyre marking. The mounted assembly was situated on the front axle of the vehicle. The measurements here were performed mostly in straight-line travel.

FIG. 2 shows a temporal signal 101 acquired with a signal acquisition frequency of 3200 Hz, allowing very fine discretization of the signal. This therefore records all variations in movement of the acceleration type at the crown of the tyre casing during rolling. This was delimited over 12 wheel turns in order to constitute the wheel-turn signal Sig^{TDR}.

The recording in FIG. 2 was performed in an acceleration phase of the vehicle, which is reflected by an increase in the amplitude of the accelerometric signal. The sensor here is a single-axis accelerometer mounted radially relative to the crown of the tyre casing, before creation of the mounted assembly by conventional fixing techniques known in the prior art. The data were transmitted by wireless communication between an electronic device galvanically connected to the accelerometer and a second radiofrequency device placed in the vehicle. In this particular case, the post-processing of the measurements was performed in the vehicle. However, it is quite possible to perform these in the first electronic device equipped with a microcontroller or microprocessor and coupled to sufficient memory space to perform the elementary mathematical operations required by the method.

Here, the first step consists of determining the reference speed, taking as reference speed the angular rotation speed. For this, the first temporal signal 101 must be phased with a reference azimuthal position of the wheel turn. To this end, the first signal 101 shows regular quite strong falls in amplitude 111, 112 which reflect the passage through the contact patch of the angular sector carrying the accelerometer. Naturally, these downward and upward slopes of the falls 111, 112 represent respectively the entry and exit of the contact patch. The centre of the contact patch is the middle of the interval separating the entry and exit of the contact patch. This centre is assigned the azimuthal position of 0 degrees which will be our azimuthal reference. By taking a second angular reference on the next signal fall 112 for example, the signal 101 is determined for a wheel turn of 360 degrees and a temporal interval associated with this wheel turn. The reference speed W^{reference} is defined as the ratio of angular variation between the two centres of the contact patch to the temporal interval separating these two azimuthal positions. This reference speed W^{reference} is assigned to the portion of the signal situated between these two centres of the contact area. Naturally, two non-contiguous falls 111, 115 of the temporal signal 101 could be considered for determining a second reference speed W^{reference} and assigning the second speed to the portion of the signal 101 situated between the two falls 111, 115.

FIG. 3 shows the result of the step of angular resampling of the temporal signal 101. Thus, using the determination of the centres of the contact patch for each fall in temporal signal performed in the preceding step, it is easy to phase the temporal signal with the wheel turn over 360 degrees. Then the discretized measurement points are linearly distributed over the wheel turn. Even if an angular positioning error is made at this step, a linear interpolation performed for example during the data aggregation step will smooth out the results and minimize the angular positioning error. In a more sophisticated fashion, a reference speed is evaluated on each wheel turn. It is possible to assign evolving angular speeds to the wheel turn by taking into account reference speeds of contiguous turns. For example, having determined the reference speeds over three consecutive turns, it is possible to assign to the central wheel turn a first reference speed for the first quarter wheel turn, being the barycentric speed of the reference speed of the preceding weighted turn 2 and the reference speed of the current weighted turn 1. The following quarter will have a reference speed being the barycentric speed of the reference speed of the current weighted turn 2 and the reference speed of the preceding weighted turn 1. The third quarter wheel turn will have a reference speed being the barycentric speed of the reference speed of the current weighted turn 2 and the reference speed of the next weighted turn 1. Finally, the last quarter wheel turn will have a reference speed being the barycentric speed of the reference speed of the current weighted turn 1 and the reference speed of the next weighted turn 2. All discretized measurement points are distributed over each quarter wheel turn in proportion to the ratio of reference speeds of each quarter turn to the reference speed of the current turn. Other methods for smoothing the points may also be applied. Here, the spatial discretization of points is not regular because of the variable rolling speed. It is quite possible to make this discretization of points of signal 102 regular by applying a method of interpolating measurement points over a given angular distribution for the wheel turn. This then provides an angularly resampled signal 102 with a regular angular pitch. FIG. 3 shows the angularly resampled signal 102 which is periodic to the wheel turn with arbitrary discretization of measurement points.

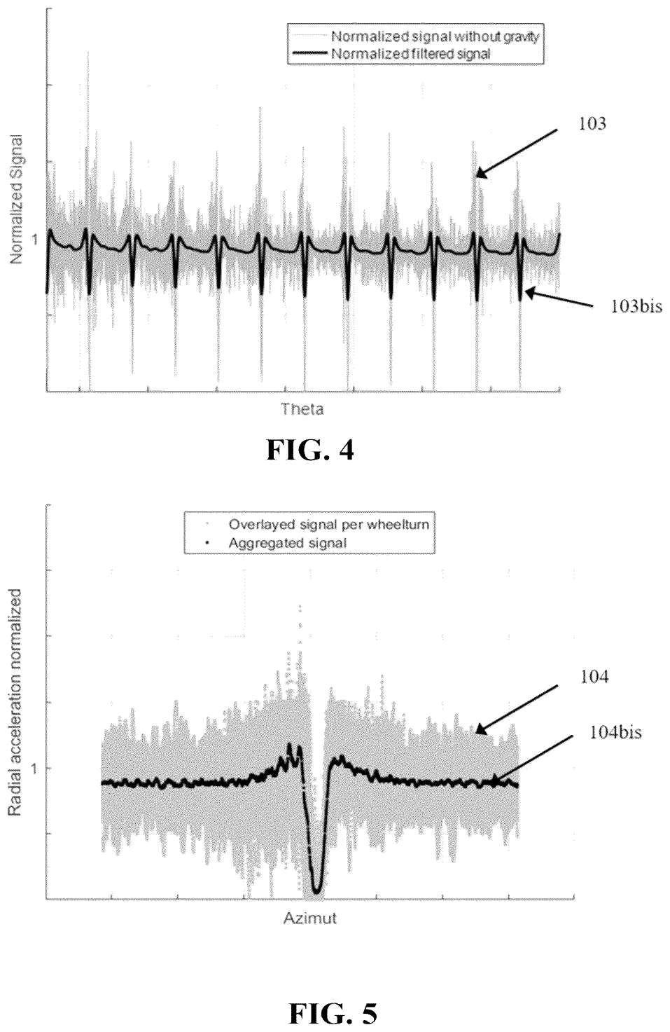

FIG. 4 shows the result of the step of normalizing the first angularly resampled signal 102 without interpolation of points. Thus, using the periodicity to the wheel turn of the first resampled signal, it is easy to break down the angular signal over a wheel turn or over a multiple of the wheel turn as illustrated in FIG. 4, here 12 wheel turns. The normalization step consists of dividing the amplitude of the signal by a function of the reference speed associated with each portion of a wheel turn. The reference speed was determined during the first signal processing step 101 for example. The function used here is the square of the reference speed, the reference speed being an angular speed. The result observed on curves 103 and 103bis is that the amplitude of the normalized signal is similar for each wheel turn. We no longer see the strong variations in amplitude between the various wheel turns performed at difference speeds and on different roads. Also, the signal is centred on the unit value. Then the wheel turn segments are superposed over the same angular interval of a length which is an integral multiple of 360 degrees, as shown by the grey curves which here form a curve bundle 103. This takes into account the spread of measurements between the wheel turns, which is accentuated by the fact that the signals have not been corrected for terrestrial gravity. However, if a low-pass filter is applied, we obtain black curve 103bis which is smoother since cleaned of parasitic noise. This allows us to see that signal 103bis is periodic to the wheel turn with slight variations between wheel turns. At the end of this normalization of signal 102, we obtain an angularly resampled normalized signal 103. FIG. 4 shows the angularly resampled normalized signal 103 which is centred on the unit value, as confirmed by the filter applied to curve 103bis.

FIG. 5 is the result of the step of aggregation of the data from signal 103 from the preceding step, which is an optional step. Here, the segments of each wheel turn are superposed over the same angular interval of a length of 360 degrees, as shown by the grey curves which here form a curve bundle 104. This takes into account the spread of measurements between each wheel turn, which is accentuated by the fact that the signals have not been corrected for terrestrial gravity. However, if we apply a correction for terrestrial gravity to each wheel turn before the normalization step, since the accelerometer is here sensitive to terrestrial gravity, data aggregation by a method of the mean over a decile interval determines the curve 104bis, which is much more stable for the wheel turn. This gives a signal for tyre casing deformation subjected to external forces, in particular the static load in this case. This signal 104bis is representative of the measurement of the tyre casing in rolling condition at variable speed on ground of any roughness. This curve is an invariant of the tyre casing in rolling condition under static load in a state mounted on the rim and inflated.

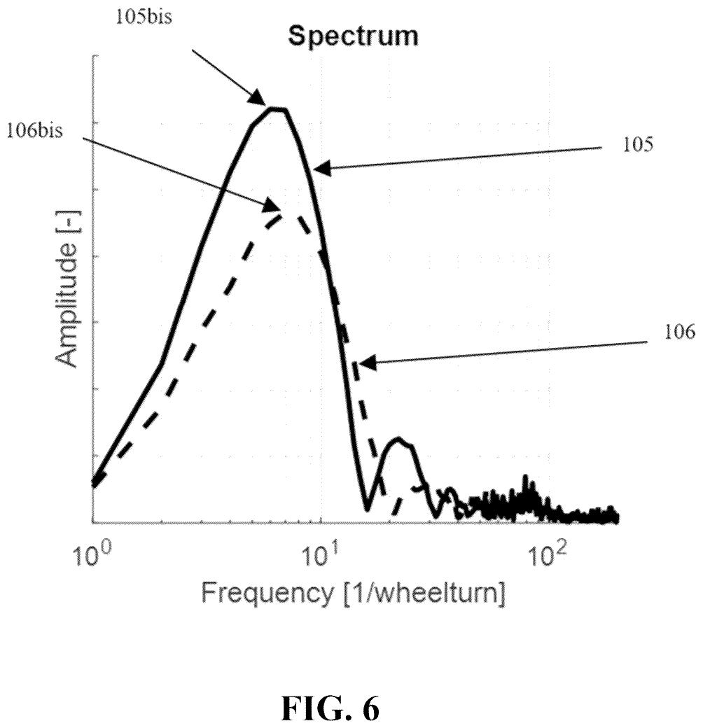

FIG. 6 shows the spectrum of the angularly resampled normalized wheel-turn signal with a fixed angular pitch of 0.1 degrees which was delimited over 12 wheel turns. In order to limit the high-frequency phenomena, the signal resulting from step 203 in the first pathway or step 204 in the second pathway was first filtered using a low-pass filter of one thirtieth of the wheel turn.

The filtered signal, or here the signal from the aggregation step in step 207, was then spectrally analysed using a Fourier transformation before obtaining curve 105, which represents the amplitude of the Fourier transformation over a limited frequency band. This curve shows various spectral blocks, a first of which has great amplitude. However, the following blocks are themselves not negligible.

It is possible to obtain multiple spectral variables from this spectral response 105. In this case we will focus on the first block, but analysis may also take place on the following blocks.

In order to take account of the sensitivity of the method, FIG. 6 shows a second dotted curve 106 which corresponds to the spectral response of the same sensor fixed to the same mounted assembly, for a different static load and a different inflation pressure, wherein the mounted assembly has been swapped between the front and rear axles of the vehicle. Thus necessarily, the mechanical response of the tyre casing to its two variables, inflation pressure and static load, is different. However, the spectral response shows a similarity in terms of form by a response in the form of successive blocks, the width and height of which are a function of external forces applied to the tyre casing.

From this, we find that analysis of the first block is sufficiently discriminating to determine the tyre casing deformation following these variations in external forces, although may not be sufficient for weaker variations in external forces applied to the tyre casing.

The spectral variables such as the maximum value, median value, mean value, pass band, area below the curve associated with the first block, are all potential criteria for differentiation of the tyre casing deformation. But also the frequency of the median value, the frequency of the mean value and the frequency of the maximum value are secondary criteria in the tyre casing deformation which show a much weaker although still discriminating dynamic.

We can then assign a tyre casing deformation value by means of a function of one or more spectral variables in the form of a vector or scalar, which may in some cases serve as weighting for the various components of the vector. Preferably, it is found that the maximum value 105bis and 106bis of the first block is a very good indicator of the tyre casing deformation, which allows determination of the tyre casing deformation through an affine function of the maximum value of the first block. However, determination of the tyre casing deformation may become more sophisticated if other spectral variables, also linked to secondary spectral blocks, are taken into account.

1-15. (canceled)

16. A method for ascertaining the deformation of a tire casing subjected to an external stress in a state mounted on a wheel so as to constitute a pneumatic mounted assembly in rolling state with rotation speed W, the tire casing having a crown in contact with a ground and in revolution about a natural rotational axis, comprising the following steps:
fastening at least one sensor to the tire casing at the crown of the tire casing so as to generate at least one output signal sensitive to movement of the at least one sensor in the tire casing;
acquiring (201) at least one first temporal signal Sig (101) comprising at least amplitude of the movement while rolling;
delimiting the first signal over a number N^{TdR} of wheel turns so as to construct a wheel-turn signal Sig^{TdR};
determining (202) at least one reference speed W^{reference} associated with at least one portion of the wheel-turn signal Sig^{TdR};
normalizing (203) the at least one portion of the wheel-turn signal by a variable which is a function F of the at least one reference speed W^{reference};
angularly resampling (204) the at least one portion of the wheel-turn signal;
obtaining (205) a spectral signal spect(Sig) of the at least one portion of the normalized and angularly resampled wheel-turn signal;
defining (206) at least one spectral variable on the spectral signal spect(Sig); and
identifying (207) a deformation Def % of the tire casing as a function G of the at least one spectral variable.

17. The method for ascertaining the deformation of a tire casing subjected to an external stress according to claim 16, wherein the step of determining (202) the reference speed W^{reference} consists of establishing a ratio of an angular variation to a temporal duration separating two azimuthal positions of the at least one sensor in the tire casing around the natural axis of rotation, from the wheel-turn signal Sig^{TDR} (101) or from a signal in phase with the wheel-turn signal Sig^{TDR} (101), according to the following formula:
$${W}^{Reference} = \frac{Δ ( α )}{Δ ( f )} \qquad [ Math 1 ]$$
wherein α is an angular position and t is a temporal abscissa associated with the angular position.

18. The method for ascertaining the deformation of a tire casing subjected to an external stress according to claim 17, wherein the angular positions of the tire casing are included in the group consisting of an angular position which can be detected from the wheel-turn signal Sig^{TDR} corresponding to an entry into a contact patch, an exit from the contact patch, or a central position of the contact patch, or any defined angular position from the signal in phase with the wheel-turn signal Sig^{TDR}.

19. The method for ascertaining the deformation of a tire casing subjected to an external stress according to claim 16, wherein an angular pitch is less than 18 degrees.

20. The method for ascertaining the deformation of a tire casing subjected to an external stress according to claim 16, wherein the at least one spectral variable is identified on a first positive frequency block of the spectral signal spect(Sig).

21. The method for ascertaining the deformation of a tire casing subjected to an external stress according to claim 20, wherein the at least one identified spectral variable is contained in the group consisting of a maximum value, a median value, a mean value, a pass-band of the first block, an area below a curve of the first block, a frequency of the median value, a frequency of the mean value, and a frequency of the maximum value.

22. The method for ascertaining the deformation of a tire casing subjected to an external stress according to claim 16, further comprising a step of aggregating data from the at least one portion of the angularly resampled normalized wheel-turn signal Sig^{TDR} over at least one sub-portion of the at least one portion of the angularly resampled normalized wheel-turn signal Sig^{TDR}, the at least one sub-portion of the at least one portion of the angularly resampled normalized wheel-turn signal Sig^{TDR} becoming the at least one portion of the angularly resampled normalized wheel-turn signal Sig^{TDR}.

23. The method for ascertaining the deformation of a tire casing subjected to an external stress according to claim 22, wherein the at least one sub-portion of the at least one portion of the wheel-turn signal Sig^{TDR} is an integral multiple of the wheel turn.

24. The method for ascertaining the deformation of a tire casing subjected to an external stress according to claim 22, wherein the data aggregation step (205) comprises a method selected from the group consisting of a mean over a decile interval, a median, a selection or interval of deciles, methods of interpolation, a weighted or non-weighted mean, and optimization of a parametric model of tire deformation.

25. The method for ascertaining the deformation of a tire casing subjected to an external stress according to claim 16, wherein the at least one sensor is selected from the group consisting of an accelerometer, a piezoelectric sensor, a magnetic sensor, an inductive sensor, and a capacitative sensor.

26. The method for ascertaining the deformation of a tire casing subjected to an external stress according to claim 16, wherein the movement of the at least one sensor is described by acceleration.

27. The method for ascertaining the deformation of a tire casing subjected to an external stress according to claim 26, wherein having phased the wheel-turn signal Sig^{TdR} (101) with respect to an angular position of the tire casing, a correction Corr is made to the wheel-turn signal Sig^{TdR} to take account of an effect of terrestrial gravity before the normalization step.

28. The method for ascertaining the deformation of a tire casing subjected to an external stress according to claim 16, wherein the first signal Sig comprises an amplitude of movement in a direction normal to the crown of the tire casing.

29. The method for ascertaining the deformation of a tire casing subjected to an external stress according to claim 16, wherein the function F is proportional to a square of the reference speed W^{reference}.

30. The method for ascertaining the deformation of a tire casing subjected to an external stress according to claim 16, wherein the function G is a linear function of the at least one spectral variable.
